(19) United States
(12) Patent Application Publication
(10) Pub. No.: US 2016/0127061 A1
(43) Pub. Date: May 5, 2016

(54) BROADCAST INTERFACE

(71) Applicant: QUALCOMM Incorporated, San Diego, CA (US)

(72) Inventors: Mohammad GHASEMAZAR, San Diego, CA (US); Hans Lee YEAGER, La Jolla, CA (US); Shanhua XUE, San Diego, CA (US)

(21) Appl. No.: 14/534,136

(22) Filed: Nov. 5, 2014

(51) Int. Cl. H04H 20/38; G06F 9/46

(52) U.S. Cl. CPC H04H 20/38; G06F 9/466

(57) ABSTRACT

An apparatus includes a transmitter configured to broadcast data to a plurality of receivers is provided. A control circuit is configured to arrange the transmitter to broadcast the data based on a protocol and to arrange the transmitter to broadcast a subset of the data in response to a request from one of the plurality of receivers. In another aspect, a method for operating a broadcast interface is provided. The method includes broadcasting data to a plurality of receivers based on a protocol and broadcasting a subset of the data in response to a request from one of the plurality of receivers. Another apparatus is provided which includes means for broadcasting data to the plurality of receivers based on a protocol and means for arranging the means for broadcasting to broadcast a subset of the data in response to a request from one of the plurality of receivers.

### BACKGROUND

1. Field

The disclosure relates to electronic apparatuses and integrated circuits (ICs), and, in particular, to electronic apparatuses and ICs with a broadcast interface.

2. Background

Wireless communication technologies and devices (e.g., cellular phones, tablets, laptops, etc.) have grown in popularity and use over the past several years. These electronic apparatuses have grown in complexity and now commonly include multiple processors (e.g., baseband processor and application processor) and other resources that allow the users to execute complex and power intensive software applications (e.g., music players, web browsers, video streaming applications, etc.). To meet the increasing performance demand, the processors have increased in complexity and operate in frequencies of gigahertz range. As a result, substantial heat may be produced while operating the processors.

The heat generated by these processors may affect the performance and the reliability of the devices. For example, the performance of an IC may degrade when operating in high temperature. Various blocks on the processor may perform thermal mitigation functions to maintain the thermal performance of the processor within a useful limit. The various thermal mitigation blocks need temperature data to perform such functions. Thus, a design challenge is providing the temperature data to various blocks on the processor in an efficient and timely manner.

### SUMMARY

Aspects of a method for operating a broadcast interface are disclosed. The method includes broadcasting data to a plurality of receivers based on a protocol and broadcasting a subset of the data in response to a request from one of the plurality of receivers.

Aspects of an apparatus are disclosed. The apparatus includes a transmitter configured to broadcast data to a plurality of receivers. A control circuit is configured to arrange the transmitter to broadcast the data based on a protocol and to arrange the transmitter to broadcast a subset of the data in response to a request from one of the plurality of receivers.

Aspects of an apparatus provided. The apparatus includes means for broadcasting data to a plurality of receivers based on a protocol and means for arranging the means for broadcasting to broadcast a subset of the data in response to a request from one of the plurality of receivers.

It is understood that other aspects of apparatus and methods will become readily apparent to those skilled in the art from the following detailed description, wherein various aspects of apparatus and methods are shown and described by way of illustration. As will be realized, these aspects may be implemented in other and different forms and its several details are capable of modification in various other respects. Accordingly, the drawings and detailed description are to be regarded as illustrative in nature and not as restrictive.

### BRIEF DESCRIPTION OF THE DRAWINGS

FIG. 1 is a diagram of an exemplary embodiment of a processor incorporating temperature sensors.

FIG. 2 is a block diagram of modules for an exemplary embodiment of a broadcast interface.

FIG. 3 is a diagram of an exemplary embodiment of a bus carrying the temperature data on the data channel.

FIG. 4 is a diagram illustrating an exemplary embodiment of a bus of the broadcast interface.

FIG. 5 is a diagram illustrating the features of an exemplary embodiment of a broadcast interface in managing requested data.

FIG. 6 is a flowchart of an exemplary embodiment for operating a broadcast interface.

FIG. 7 is a flowchart of another exemplary embodiment for operating a broadcast interface.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts. The term “exemplary” is used herein to mean “serving as an example, instance, or illustration.” Any design described herein as “exemplary” is not necessarily to be construed as preferred or advantageous over other designs.

Several aspects of the disclosure will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof Whether such elements are implemented as hardware or software depends upon the particular application and design constraints imposed on the overall system. Various apparatus and methods presented throughout this disclosure may be implemented in various forms of hardware. By way of example, any of these apparatus or methods, either alone or in combination, may be implemented as an integrated circuit, or as part of an integrated circuit. The integrated circuit may be an end product, such as a microprocessor, a digital signal processor (DSP), an application specific integrated circuit (ASIC), programmable logic, or any other suitable integrated circuit. Alternatively, the integrated circuit may be integrated with other chips, discrete circuit elements, and/or other components as part of either an intermediate product, such as a motherboard, or an end product.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The word “exemplary” is used herein to mean serving as an example, instance, or illustration. Any embodiment described herein as “exemplary” is not necessarily to be construed as preferred or advantageous over other embodiments. Likewise, the term “embodiment” of an apparatus or method does not require that all embodiments of the invention include the described components, structure, features, functionality, processes, advantages, benefits, or modes of operation.

The terms “connected,” “coupled,” or any variant thereof, mean any connection or coupling, either direct or indirect, between two or more elements, and can encompass the presence of one or more intermediate elements between two elements that are “connected” or “coupled” together. The coupling or connection between the elements can be physical, logical, or a combination thereof. As used herein, two elements can be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Any reference to an element herein using a designation such as “first,” “second,” and so forth does not generally limit the quantity or order of those elements. Rather, these designations are used herein as a convenient method of distinguishing between two or more elements or instances of an element. Thus, a reference to first and second elements does not mean that only two elements can be employed, or that the first element must precede the second element.

As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of the stated features, integers, steps, operations, elements, and/or components, but do not preclude the presence or addition of one or more other features, integers, steps, operations, elements, components, and/or groups thereof.

Various aspects of apparatus and methods for an efficient inter-block communication for a hardware block to send data to multiple other hardware blocks are provided. The data may be broadcasted periodically and/or as-needed. Examples of the data may include die temperature and/or global dynamic power/current budget allocation. However, as those skilled in the art will readily appreciate, aspects and applications of the disclosure may not be limited thereto. For example, the features presented may be applicable to other ICs besides a processor and applicable to functions beyond wireless communication. Accordingly, all references to a specific application for the presented apparatus or method are intended only to illustrate exemplary aspects of the apparatus or method with the understanding that such aspects may have a wide differential of applications.

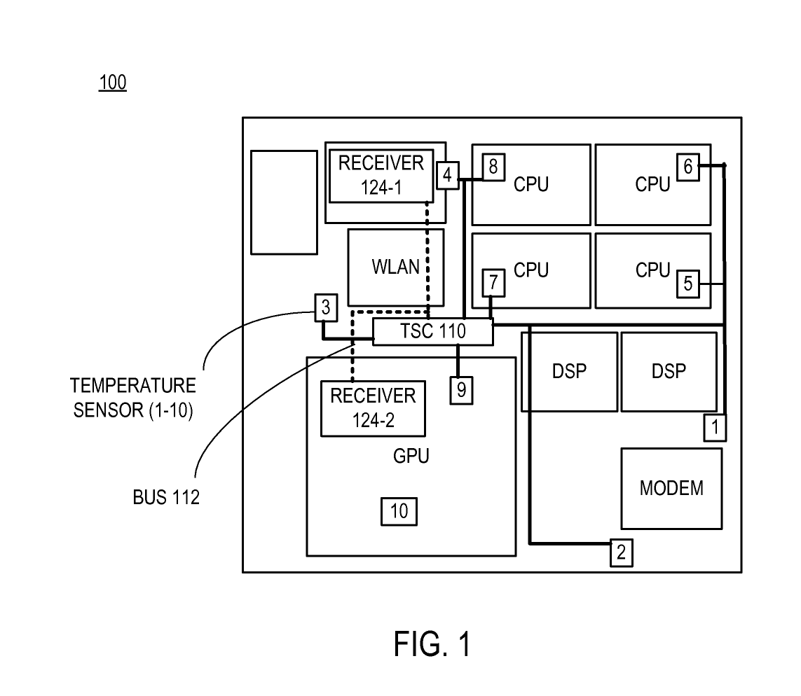

FIG. 1 is a diagram of an exemplary embodiment of a processor incorporating temperature sensors. The processor 100 may be a processor for wireless communication, such as an application or a baseband processor for a cell phone. The processor 100 includes various cores or blocks of circuits, such as graphic processor unit (GPU), digital signal processors (DSP), modem, central processing units (CPU), and a wireless local area network or WLAN block. A core may be, for example, a collection of circuits. The processor 100 also includes various temperature sensors (1-10). In one implementation, the temperature sensors (1-10) output the measured temperatures in periodic intervals. The temperature sensors (1-10) provide the measured temperatures to the temperature sensor controller or TSC 110.

In one configuration, the TSC 110 may transmit the temperature data to various receivers 124-1, 124-2 via the bus 112. The receivers 124-1, 124-2 may include Limits Management (LM) hardware and Digital Power Meter (DPM) blocks, which utilize the temperature data for thermal management and leakage power estimation. A point-to-point communication may be more expensive than a broadcast scheme in terms of routing costs and energy consumption. The cost may be particularly high when the sent data to the various receivers 124-1, 124-2 include overlaps. A point-to-multipoint or broadcast bus may be more efficient, but is a one-way transfer of data. The need may arise for a receiver (e.g., 124-1 or 124-2) to receive some particular data with low-latencies. For example, the receiver (124-1 or 124-2) may have missed or dropped data packets during a broadcast. In another example, the receiver (124-1 or 124-2) may have returned from a power collapse and lost all temperature data. In these examples, a low-latency scheme for receiving temperature data may be more beneficial than a broadcast system.

In one exemplary embodiment, the TSC 110 sends or transmits the temperature data to the receivers 124-1, 124-2 via the bus 112 by means of broadcasting. Further, the TSC 110 is configured to handle requests from the receivers 124-1, 124-2 and provide data associated with the request via the same bus 112 on a low-latency basis. Various features of the exemplary embodiment are presented below. Each of the receivers 124-1, 124-2 may send a request for data to the TSC 110. Each of the requests may request multiple portions of temperature data (e.g., each portion corresponds to a temperature from a temperature sensor). The requests may be static data requests in terms of the associated subsets of temperature data. For example, each request may stand for requesting a static subset of temperature data associated with the request. For example, each request from the receiver (124-1 or 124-2) requests same subset of temperature data. In another example, the request may be dynamic. For example, a register may store information indicating a subset of temperature data to be associated with a receiver (124-1 or 124-2). The TSC 110 in this case may broadcast the subset of temperature data associated with the receiver (124-1 or 124-2) making the request. In one example, the information indicating the subset of temperature data to be associated with the receiver (124-1 or 124-2) stored in the register may be modified by, e.g., software.

Another of aspect of the exemplary embodiment relate to resolving priorities in a case the TSC 110 receives multiple requests from more than one of the receivers in a same cycle. The resolution may include deciding which of the multiple requests may be serviced first and in what order. The priorities may be first-come-first-serve or multiple levels for requests and real-time. The higher priorities of the requests may be interrupting (preemptive) or non-interrupting. The priority assignment may be static or dynamic. For example, a dynamic priority assignment may assign a higher priority to a least recently served receiver.

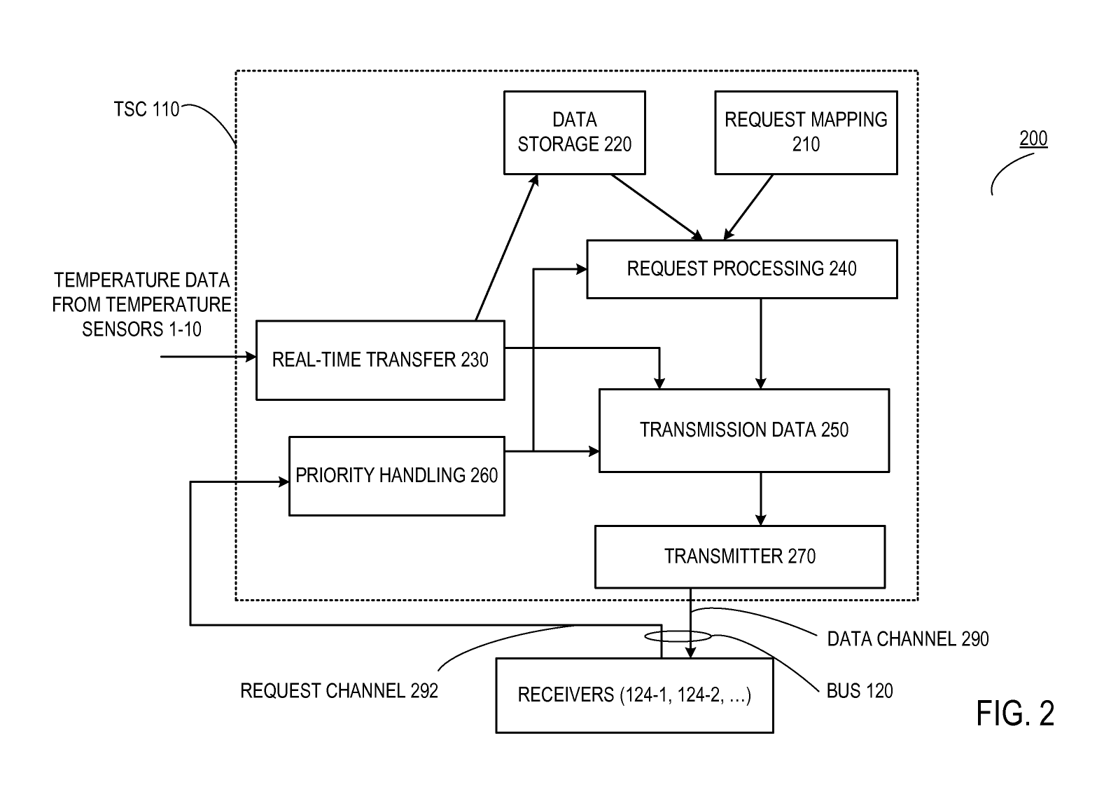

FIG. 2 is a block diagram of modules for an exemplary embodiment of a broadcast interface. An apparatus, such as the processor 100, may include the exemplary embodiment of the broadcast interface. The broadcast interface may include the TSC 110, which contains various modules to operate the bus 120. The various modules of the TSC 110 presented may be an example of a control circuit. The various modules presented may be implemented in hardware/circuit, software, or combination thereof in accordance with the knowledge of persons of ordinary skill in the art. For example, the modules may include logic gates to perform the functions described herein, processor(s) performing those functions, circuits generating the signals for the functions described herein, or combinations thereof.

By way of example, a module, or any portion of a module, or any combination of modules may be implemented with a “processing system” that includes one or more processors executing software. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The bus 120 includes a data channel 290, via which the temperature data are broadcasted to the receivers (124-1, 124-2, etc.). The bus 120 further includes a request channel 292, via which the requests for data are sent from the receivers (124-1, 124-2, etc.) to the TSC 110. The TSC 110 includes a real-time transfer module 230 which receives the temperature data (e.g., the real-time measured temperatures) from the temperature sensors 1-10. In one example, the temperature sensors 1-10 measure the temperatures periodically. In one configuration, the TSC 110 broadcasts the received temperature data on the data channel 290 of the bus 120.

In one configuration, the TSC 110 broadcasts the received temperature data (e.g., real-time temperatures measured by temperature sensors 1-10) based on a protocol. In one example, the protocol is a sequence. For example, in a cycle, the TSC 110 receives and broadcasts (to the receivers 124-1, 124-2, etc.) the real-time temperature measured by the temperature sensor 1. In a second cycle, the TSC 110 receives and broadcasts (to the receivers 124-1, 124-2, etc.) the real-time temperature measured by the temperature sensor 2, and so forth. Thus, in each cycle, the TSC 110 receives and broadcasts a portion of the temperature data (e.g., the real-time temperature measured by one of the temperature sensors 1-10 for the cycle).

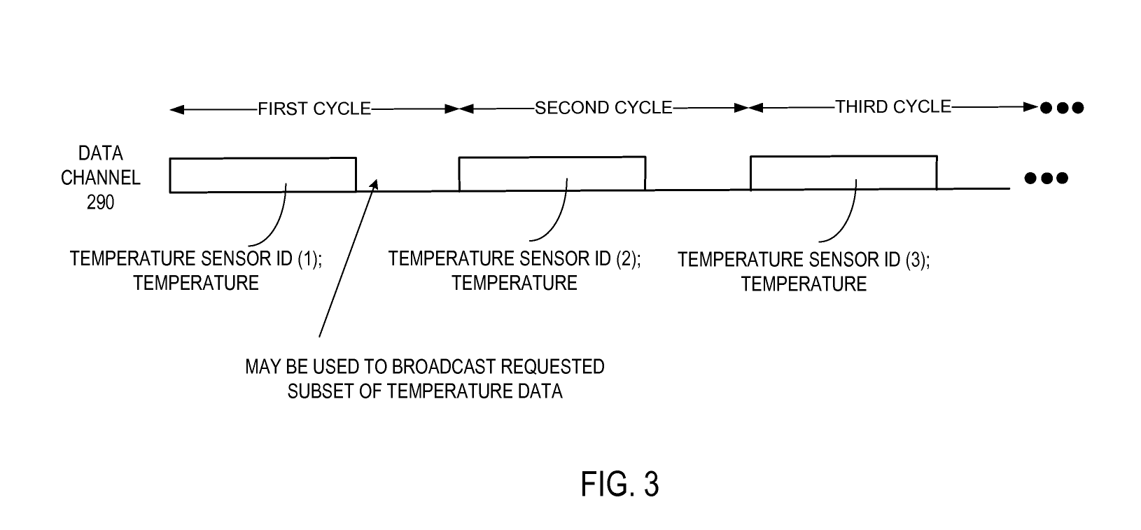

FIG. 3 is a diagram of an exemplary embodiment of a bus carrying the temperature data on the data channel. In the first cycle, the temperature sensor 1 measures the temperature and provides the (real-time) measured temperature to the real-time transfer module 230. The real-time transfer module 230 provides the temperature data to the transmission data module 250, which selects the provided real-time temperature data of the temperature sensor 1. The data from the transmission data module 250 are transmitted by the transmitter 270 via the data channel 290 of the bus 120 and provided to the receivers (124-1, 124-2, etc.).

FIG. 3 illustrates that in the first cycle, the data channel 290 transmits data including the temperature sensor identification (ID), which is one in the first cycle, and the temperature measured by the temperature sensor 1. In the second cycle, the temperature sensor 2 measures the temperature and provides the (real-time) measured temperature to the real-time transfer module 230. The data channel 290 transmits data including the temperature sensor identification ID (two in the second cycle) and the temperature measured by the temperature sensor 2. In the third cycle, the temperature sensor 3 measures the temperature and provides the measured temperature to the real-time transfer module 230. The data channel 290 transmits data including the temperature sensor identification ID (three in the third cycle) and the temperature measured by the temperature sensor 3, and so forth.

In one example, a cycle may be 100 μs, and the broadcast data does not take up the entire cycle (as shown in FIG. 3). In this case, the requested subset of temperature data may be broadcasted in a same cycle as the real-time temperature broadcast presented above. In this fashion, the broadcast interface may operate efficiently.

Referring to FIG. 2, the real-time transfer module 230 may provide the received (real-time) temperature data from the temperature sensors to the data storage module 220. The data storage module 220 may be, e.g., registers storing the temperature data. In one example, the data storage module 220 includes control and status registers, and the temperature data stored therein are read by software. In one example, the data storage module 220 stores the most recent temperatures measured by the temperature sensors 1-10. The stored temperature data are provided to the request processing module 240 (features of which are presented below). In one example, the temperature data may include the temperature data stored in the data storage module 220 and the real-time temperature from the real-time transfer 230. A subset of temperature data may include any portion or unit of temperature data stored in the data storage module 220 and the real-time temperature from the real-time transfer 230.

Referring to FIG. 2, any one of the receivers (124-1, 124-2, etc.) may utilize the request channel 292 of the bus 120 for sending a request for a subset of temperature data. The subset of temperature data may range from temperature measured from one temperature sensor to temperatures measured from all of the temperature sensors. The request is received by the priority handling module 260 of the TSC 110. The priority handling module 260 resolves priority issues as presented above. For example, in a case where two requests are received in the same cycle, the priority handling module 260 may determine the priorities of the requests based on, e.g., the first-come-first-serve or the least-recently-served scheme. The requests may then be provided to the request processing module 240 and the transmission data module 250.

The request processing module 240 receives information indicating the subset of temperature data to be associated with each request from the request mapping module 210. In one example, the request mapping module 210 is a memory or register unit that may be modified or programmed. For example, each request may be associated with a dedicated (e.g., software) register indicating its corresponding sensor indexes (which provide the subset of temperature data). Thus, the subset of temperature data may be dynamically associated with a request. For example, the request processing module 240 may indicate that temperatures measured by temperature sensors 1 and 2 are to be associated with a request from the receiver 124-1. Subsequently, the request processing module 240 may be modified to indicate that temperatures measured by temperature sensors 1, 2, and 3 are to be associated with a request from the receiver 124-1.

Based on the received requests and the information of subsets of temperature data to be associated with the requests, the request processing module 240 may provide the subsets of the temperature data (associated with the requests) from the data storage module 220 to the transmission data module 250. In this case, the TSC 110 is configured to broadcast the requested subset of temperature data previously stored in the data storage module 220 (as opposed to the real-time temperature from the real-time transfer module 230).

The transmission data module 250 then selects from among the stored temperature data and the real-time temperatures from the real-time transfer module 230, based on the requests from the priority handling module 260. The transmission data module 250 then provides the selected temperature data to the transmitter 270. The transmitter 270 broadcasts the temperature data to the receivers (124-1, 124-2, etc.) via the data channel 290 of the bus 120. As described above, the transmission data module 250 may be an example of a control circuit that arranges the transmitter 270 to broadcast the data based on a protocol (e.g., in a sequence of the temperature sensors 1-10 detecting temperatures) and arranges the transmitter 270 to broadcast a subset of the data in response to a request from one of the plurality of receivers (124-1, 124-2, etc.).

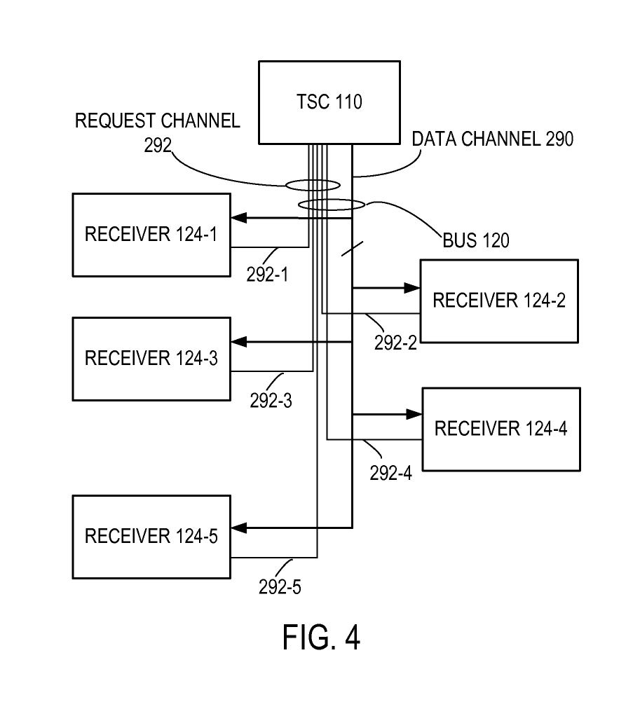

FIG. 4 is a diagram illustrating an exemplary embodiment of the bus of the broadcast interface. The TSC 110 broadcast the temperature data to the receivers 124-1, 124-2, 124-3, 124-4, and 124-5 via the data channel 290 of the bus 120. The receivers 124-1, 124-3, and 124-5 may be, for example, LM hardware. The receivers 124-2 and 124-4 may be, for example, DPMs. Any of the receivers 124-1, 124-2, 124-3, 124-4, and 124-5 may request a subset of temperature data to reduce the latency of getting such information. As presented above, for example, a receiver may return from a power-collapse event and would need the temperature information as soon as possible. Waiting for the periodic broadcast on the data channel 290 may require a long latency before the needed data are broadcasted.

In one configuration, the TSC 110 is configured to receive the request from the any one of the receivers 124-1, 124-2, 124-3, 124-4, and 124-5 on the request channel 292. The request channel 292 is different from the data channel 290. The request channel 292 may include multiple signal line 292-1, 292-2, 292-3, 292-4, and 292-5. Each of the signal line is coupled between the TSC 110 and a corresponding one of the receivers 124-1, 124-2, 124-3, 124-4, and 124-5.

For example, the receiver 124-1 may make a request for the subset of temperature data associated with the receiver 124-1 via the single signal line 292-1, which connects or couples the receiver 124-1 and the TSC 110. In one example, the receiver 124-1 may make such request by asserting the single signal line 292-1 (e.g., charging the single signal line 292-1 to a high state). Upon receiving the request subset of temperature data on the data channel 290, the receiver 124-1 may de-assert the single signal line 292-1 (e.g., discharging the single signal line 292-1 to a low state). Thus, the TSC 110 is configured to recognize the request from the any one of the multiple receivers (e.g., 124-1, 124-2, 124-3, 124-4, and 124-5) in response to the corresponding one of the signal lines (e.g., respectively 292-1, 292-2, 292-3, 292-4, and 292-5) being in a first or high state, and to recognize that such request is resolved in response to the corresponding one of the single signal lines being in a second or low state. In response, the TSC 110 broadcasts the requested subsets of temperature data on the data channel 290, which is different from the request channel 292.

In one configuration, the TSC 110 resolves duplicated subsets of the temperature data for each cycle. In one example, the request processing module 240 performs such resolution by utilizing a list (e.g., a to-do list). When a new request is received, the associated temperature sensors IDs are added to the list. The request processing module 240 may fetch the subsets of temperature data from the data storage module 220 based on the list. Once the list is finished, the TSC 110 may check for new requests. If none exists, the TSC 110 may resume the real-time broadcast. If two or more requests arrive simultaneously (e.g., within a clock cycle), the TSC 110 may update the list to contain all the requested subsets of temperature data. In case of duplication among the requested subsets of temperature data (e.g., the temperature measured by the temperature sensor 1 is requested more than once), the duplicated subsets may be transmitted only once. A subset of temperature data serviced (e.g., transmitted) in a current cycle may not be added to the list for the current cycle. This scheme accounts for a delay by the requesting receiver to de-assert the corresponding request line. In a case that a subset of temperature data is transmitted in a current cycle but the requesting signal line remains asserted, the request for the transmitted subset of temperature data may be considered new for a subsequent cycle and added to the list.

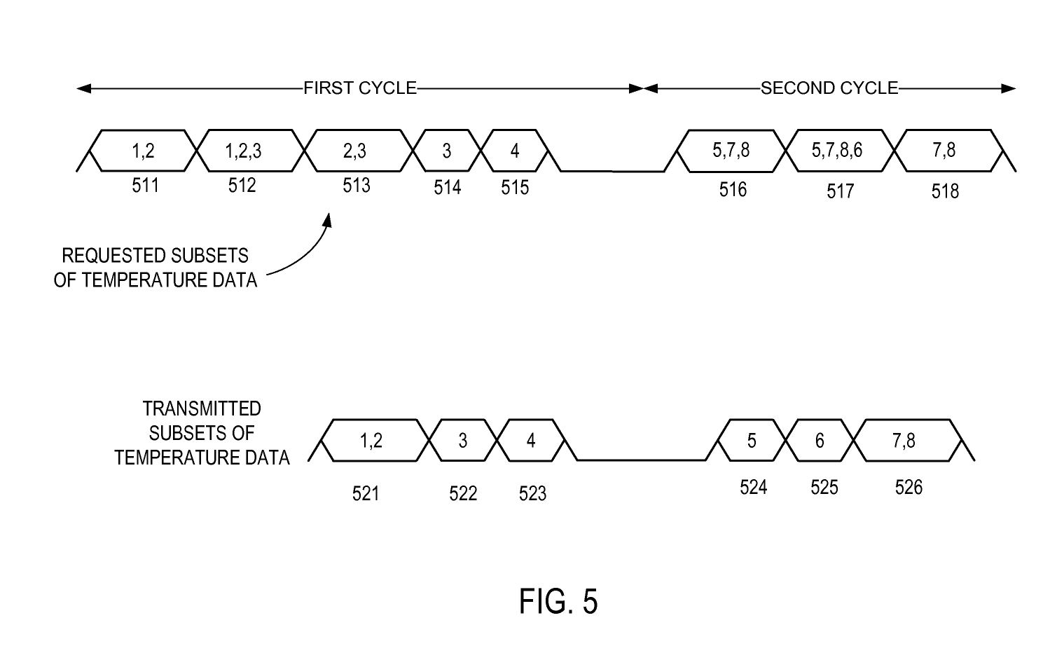

FIG. 5 is a diagram illustrating the features of an exemplary embodiment of a broadcast interface in managing requested data. In the first cycle, the request 511 requests subsets of temperature data from temperature sensors 1 and 2. The request 512 requests subsets of temperature data from temperature sensors 1, 2, and 3, and so forth. In the first cycle, the subset of temperature data from the temperature sensor 3 is requested three times by the request 512, 513, and 514. The TSC 110 transmits or broadcasts the requested subsets of temperature data at 512, 522, and 523. The subset of temperature data from the temperature sensor 3 is transmitted only once at 522 to avoid duplication.

In the second cycle, the request 517 requests the subset of temperature data from the temperature sensor 6 after the subset has been transmitted or broadcasted at 525. In this case, the request 517 of the subset of temperature data from the temperature sensor 6 is considered resolved by the TSC 110.

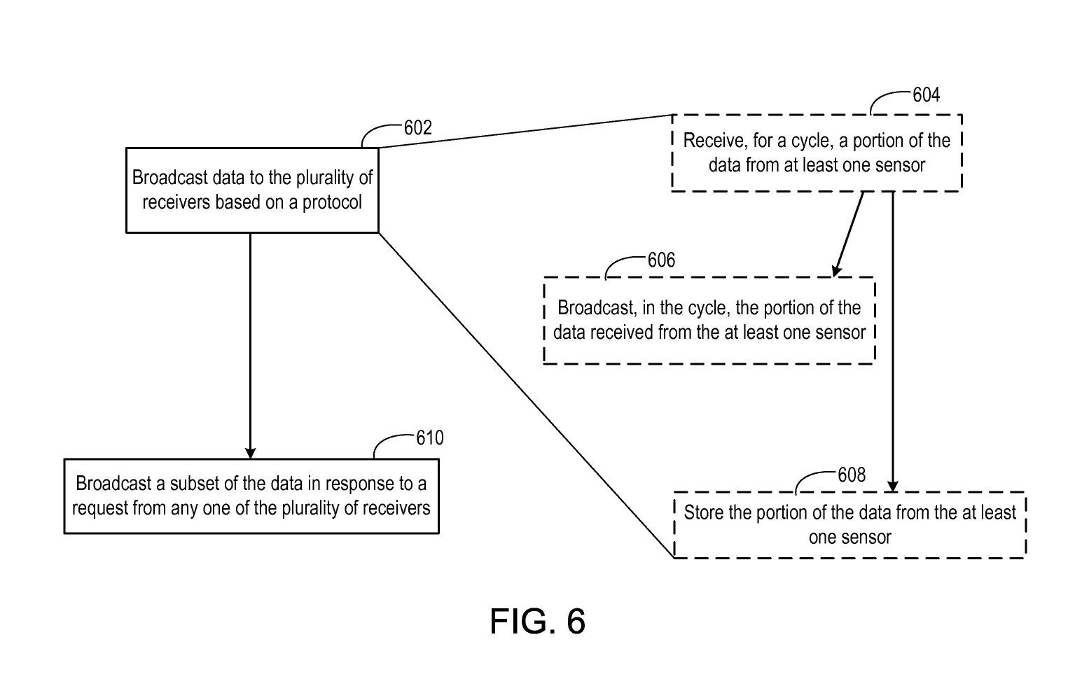

FIG. 6 is a flowchart of an exemplary embodiment for operating a broadcast interface. The steps boxed in dotted line may be optional. At 602, data are broadcasted to the plurality of receivers based on a protocol. For example, referring to FIGS. 2 and 3 and the associated text, the transmitter 270 provides the means to broadcast the temperature data, in a sequence, to the receivers (124-1, 124-2, etc.) via the data channel 290 of the bus 120. The sequence may be the real-time temperature measured by the temperature sensor 1, the real-time temperature measured by the temperature sensor 2, the real-time temperature measured by the temperature sensor 3, and so forth.

At 604, a portion of the data is received from at least one sensor. For example, referring to FIGS. 2 and 3 and the associated text, the real-time transfer module 230 provides the means to receive, for a cycle, a real-time temperature from one of the temperature sensors 1-10. The received real-time temperature is an example of a portion of the temperature data. At 606, the portion of the data from the at least one sensor is broadcast in the cycle. Referring to FIGS. 2 and 3 and the associated text, the TSC 110 provides the means to broadcast the received real-time temperature in the cycle. At 608, the portion of the data from the at least one sensor is stored. For example, referring to FIGS. 2 and 3 and the associated text, the data storage module 220 stores the received real-time temperature.

At 610, a subset of the data is broadcasted in response to a request from any one of the plurality of receivers. For example, referring to FIGS. 2 and 3 and the associated text, the priority handling module 260 receives one or more requests for data from the receivers (124-1, 124-2, etc.) via the request channel 292 of the bus 120. The subset of temperature data associated with a request is assembled by means of the request mapping module 210, data storage module 220, request processing module 240, and/or the transmission data module 250. For example, the request mapping module 210, data storage module 220, and the request processing module 240, and/or the transmission data module 250 provide the means to arrange the transmitter 270 to broadcast the subset of temperature data associated with a request.

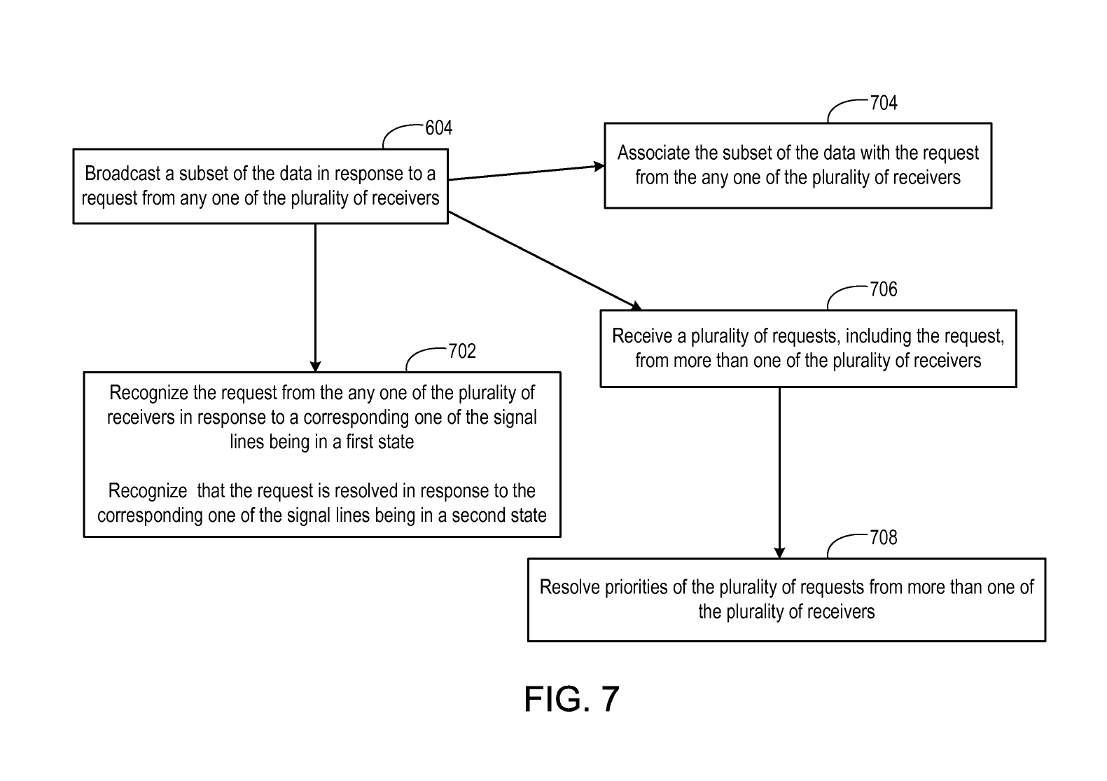

FIG. 7 is a flowchart of another exemplary embodiment for operating a broadcast interface. The steps boxed in dotted line may be optional. At 702, the request from the any one of the plurality of receivers is recognized in response to a corresponding one of the signal lines being in a first state. The request being resolved is recognized in response to the corresponding one of the signal lines being in a second state. For example, referring to FIG. 4 and the associated text, the receiver 124-1 may make a request for data by asserting the signal line 292-1 (the corresponding one of the signal lines) to a high state. The request would be recognized by the TSC 110.

At 704, the subset of the data is associated with the request from the any one of the plurality of receivers. For example, referring to FIGS. 2 and 3 and the associated text, the request mapping module 210 provides the means to associate the subset of data (e.g., temperatures from one or more temperature sensors stored in the data storage module 220) with a request. For example, the request mapping module may store information indicating that for a request from 124-1, temperature data from temperature sensor 1 and temperature sensor 2 are to be associated thereto.

At 706, a plurality of requests from more than one of the plurality of receivers is received. For example, referring to FIGS. 2 and 4 and the associated text, the TSC 110 provides the means to receive a plurality of requests on the request channel 292 (via the signal lines 292-1-292-5). At 708, priorities of the plurality of requests from more than one of the plurality of receivers are resolved. For example, referring to FIG. 2 and the associated text, the priority handling module 260 may provide the means to resolve the priorities of the plurality of requests. The resolution may include deciding which of the multiple requests may be serviced first. The priorities may be first-come-first-serve or multiple levels for requests and real-time. The higher priorities of the requests may be interrupting (preemptive) or non-interrupting. The priority assignment may be static or dynamic. For example, a dynamic priority assignment may assign a higher priority of a least recently served receiver.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112(f) unless the element is expressly recited using the phrase “means for” or, in the case of a method claim, the element is recited using the phrase “step for.”

What is claimed is:

1. An apparatus, comprising:
a transmitter configured to broadcast data to a plurality of receivers; and
a control circuit configured to arrange the transmitter to broadcast the data based on a protocol, and to arrange the transmitter to broadcast a subset of the data in response to a request from one of the plurality of receivers.

2. The apparatus of claim 1, wherein the protocol comprises broadcasting the data in a sequence.

3. The apparatus of claim 1, wherein the data comprises data from at least one sensor.

4. The apparatus of claim 3, wherein, for a cycle, the control circuit is configured to receive a portion of the data from the at least one sensor and to broadcast the portion of the data.

5. The apparatus of claim 3, wherein, for a cycle, the control circuit is configured to receive a portion of the data from the at least one sensor and to store the portion of the data.

6. The apparatus of claim 5, wherein the subset of the data comprises the stored portion of the data, and the control circuit is configured to broadcast the subset of the data including the stored portion of the data in response to the request.

7. The apparatus of claim 1, wherein the control circuit is configured to receive a second request from a second one of the plurality of receivers.

8. The apparatus of claim 7, wherein the control circuit is configured to resolve priorities of the requests.

9. The apparatus of claim 8, wherein the control circuit is configured to resolve the priorities by first-come-first-serve.

10. The apparatus of claim 9, wherein the control circuit is configured to resolve the priorities by least-recently-served.

11. The apparatus of claim 1, further comprising a register configured to store information indicating an association between the subset of the data and the request, wherein the control circuit is configured to associate the subset of the data with the request based on the stored information.

12. The apparatus of claim 1, further comprising a request channel, wherein the control circuit is further configured to receive the request from the one of the plurality of receivers on the request channel.

13. The apparatus of claim 12, wherein the request channel comprises a plurality of signal lines, each of the signal lines being coupled between the control circuit and a corresponding one of the plurality of receivers.

14. The apparatus of claim 13, wherein the control circuit is configured to recognize the request from the one of the plurality of receivers in response to the corresponding one of the signal lines being in a first state, and to recognize that the request is resolved in response to the corresponding one of the signal lines being in a second state.

15. The apparatus of claim 12, further comprising a data channel, wherein the transmitter is configured to broadcast the data and the subset of the data on the data channel, and wherein the data channel is different from the request channel.

16. A method for operating a broadcast interface, comprising:
broadcasting data to a plurality of receivers based on a protocol; and
broadcasting a subset of the data in response to a request from one of the plurality of receivers.

17. The method of claim 16, wherein the protocol comprises broadcasting the data in a sequence.

18. The method of claim 16, wherein the data comprises data from at least one sensor.

19. The method of claim 18, further comprising:
receiving, for a cycle, a portion of the data from the at least one sensor; and
broadcasting, in the cycle, the portion of the data received from the at least one sensor.

20. The method of claim 18, further comprising:
receiving, for a cycle, a portion of the data from the at least one sensor; and
storing the portion of the data from the at least one sensor.

21. The method of claim 20, wherein the subset of the data comprises the stored portion of the data, further comprising broadcasting the subset of the data including the stored portion of the data in response to the request.

22. The method of claim 16, further comprising receiving a second request from a second one of the plurality of receivers.

23. The method of claim 22, further comprising resolving priorities of the requests.

24. The method of claim 16, further comprising associating the subset of the data with the request from the one of the plurality of receivers.

25. The method of claim 16, wherein the request from the one of the plurality of receivers is received on a request channel.

26. The method of claim 25, wherein the request channel comprises a plurality of signal lines, each of the signal lines being coupled to a corresponding one of the plurality of receivers.

27. The method of claim 26, further comprising recognizing the request from the one of the plurality of receivers in response to the corresponding one of the signal lines being in a first state; and recognizing that the request is resolved in response to the corresponding one of the signal lines being in a second state.

28. The method of claim 25, wherein the data and the subset of the data are broadcasted on a data channel, and wherein the data channel is different from the request channel.

29. An apparatus, comprising:
means for broadcasting data to a plurality of receivers based on a protocol; and
means for arranging the means for broadcasting to broadcast a subset of the data in response to a request from one of the plurality of receivers.

30. The apparatus of claim 1, wherein the protocol comprises broadcasting the data in a sequence.
